(19) United States
(12) Patent Application Publication
(10) Pub. No.: US 2009/0103727 A1
(43) Pub. Date: Apr. 23, 2009

(54) Sync-bit Insertion for Timing Reference Signals to Prevent Long Runs of Static Data in Serial Digital Interfaces

(76) Inventors: Gareth M. Heywood, Waterdown (CA); John Hudson, Burlington (CA)

Correspondence Address: PATENT GROUP 2N;JONES DAY, NORTH POINT, 901 LAKESIDE AVENUE, CLEVELAND, OH, 44114, US

(21) Appl. No.: 12/248,405

(22) Filed: Oct. 9, 2008

Related U.S. Application Data
(60) Provisional application No. 60/980,618, filed on Oct. 17, 2007.

(51) Int. Cl. H04N 7/167; G06F 13/42

(52) U.S. Cl. 380/210; 710/71

(57) ABSTRACT

In accordance with the teachings described herein, systems and methods are provided for inserting 2-bit codes into the least significant bit positions of timing reference signal code words, to prevent long runs of zeros from entering the scrambling polynomial. By preventing the long runs of ones and zeros in the scrambled data stream, the receive-end DC-restoration circuits can be simplified, reducing complexity and increasing system performance. A serial digital interface prevents long runs of ones and zeros by replacing the values of the two least significant bits of the data stream prior to the scrambler. The two least significant bits are changed from 11b or 00b to 01b or 10b.

### CROSS-REFERENCE TO RELATED APPLICATIONS

This application claims priority from U.S. Provisional Patent Application No. 60/980,618, filed on Oct. 17, 2007, and entitled “Sync-bit Insertion for Timing Reference Signals to Prevent Long Runs of Static Data in Serial Digital Interfaces,” the entirety of which is incorporated herein by reference.

### FIELD

The technology described in this patent document relates generally to serial data interfaces used in video systems. More specifically, systems and methods are provided for inserting 2-bit codes into the least significant bit positions of high-definition serialized data streams.

### BACKGROUND

The Serial Digital Interface (SDI), used in broadcast and professional video systems, uses a scrambling polynomial and NRZI encoding. When the scrambler is seeded appropriately, there is an input pattern which will clear all the registers. If the remaining input data is all zeros, then only zeros will be emitted from the scrambler. Although legal video signals are restricted from containing all-zero data words, they do show up in the Timing Reference Signals (TRS) code words used to identify the beginning and end of an active line of video.

High-definition video signals use separate TRS code words for the luma and chroma channels, as mandated in SMPTE 292, Clause 6.1. Thus, for each line of video, there is a pair of EAV/SAV code words for the luma channel, and another for the chroma channel. When these streams are multiplexed prior to serialization, the TRS code words are also multiplexed, resulting in 40 consecutive zeros after serialization. If the scrambler is seeded appropriately, this results in 59 consecutive zeros out of the scrambler, or 59 consecutive ones or zeros out of the NRZI encoder.

SMPTE 425M also defines a virtual interface for mapping two SMPTE 292 data streams into a single 10-bit multiplexed data stream (Level B mapping). This results in four complete sets of TRS, Line Number and CRC code word. The serialized stream feeding the scrambler contains 80 consecutive zeros during the multiplexed TRS code words. This implies that it is possible for the NRZI encoder to emit up to 99 consecutive ones or zeros.

Requirements within the video industry to reduce the number of physical links between facilities, equipment racks, and outside broadcast vehicles can be addressed by combining multiple high-definition video signals over a higher bandwidth serial interface. This is also a requirement within large pieces of equipment, such as serial video routers, to reduce the size and complexity of high-speed interconnect. Combining multiple high-definition signals by multiplexing the video data streams results in much longer runs of zeros due to the concatenated TRS code words.

These long runs of zeros or ones can cause non-optimum performance in receive devices which employ cable equalization and/or DC restoration, resulting in data errors or failure to recover the original data. DC offsets are created by the long run of ones or zeros, requiring the signal to be “DC-restored” at the receive-end. The DC restoration process may add unwanted jitter, reducing timing margin.

### SUMMARY

In accordance with the teachings described herein, systems and methods are provided for inserting 2-bit codes into the least significant bit (LSB) positions of the TRS code words, to prevent long runs of zeros from entering the scrambling polynomial. By preventing the long runs of ones and zeros in the scrambled data stream, the receive-end DC-restoration circuits can be simplified, reducing complexity and increasing system performance.

A method of reducing long runs of static data in serial digital interfaces may include the following steps: receiving a data stream including a plurality of ten-bit data words in a high-definition video signal; modifying each of two least significant bits of a plurality of ten-bit data words in the preamble of the data stream to reduce the number of consecutive ones or zeros in the data stream; and after modifying the two least significant bits, applying a scrambling polynomial to the data stream to generate a scrambled high-definition serialized data stream.

One example system may include a video transmission system comprising: a serial digital video transmitter configured to receive a parallel video stream, the parallel video stream including a preamble made up of parallel code words, the serial digital video transmitter being further configured to modify the two least significant bits of a plurality of the parallel code words that make up the preamble of the parallel video stream, the serial digital video transmitter being further configured to serialize the parallel video stream to generate a serial video signal that includes a serialized preamble, wherein the modification of the two least significant bits of a plurality of the parallel code words prevents the serialized preamble from including more than a predetermined number of consecutive ones or zeros.

### BRIEF DESCRIPTION OF THE DRAWINGS

FIG. 1 is a system diagram of an example serial digital video interface configured to insert a sync-bit into the two least significant bits of a high-definition data stream.

FIG. 2 illustrates multiplexed timing reference signal preambles.

FIGS. 3 and 4 are examples of serialized timing reference signal preambles.

FIG. 5 is an example of inserting a sync-bit into the two least significant bits of a parallel data stream.

FIG. 6 is an example of serialized 3FFh words after a sync-bit has been inserted into the data stream.

FIG. 7 is an example of serialized 000h words after a sync-bit has been inserted into the data stream.

FIG. 8 is an example of serialized 000h words after a sync-bit has been periodically inserted into the data stream.

### DETAILED DESCRIPTION

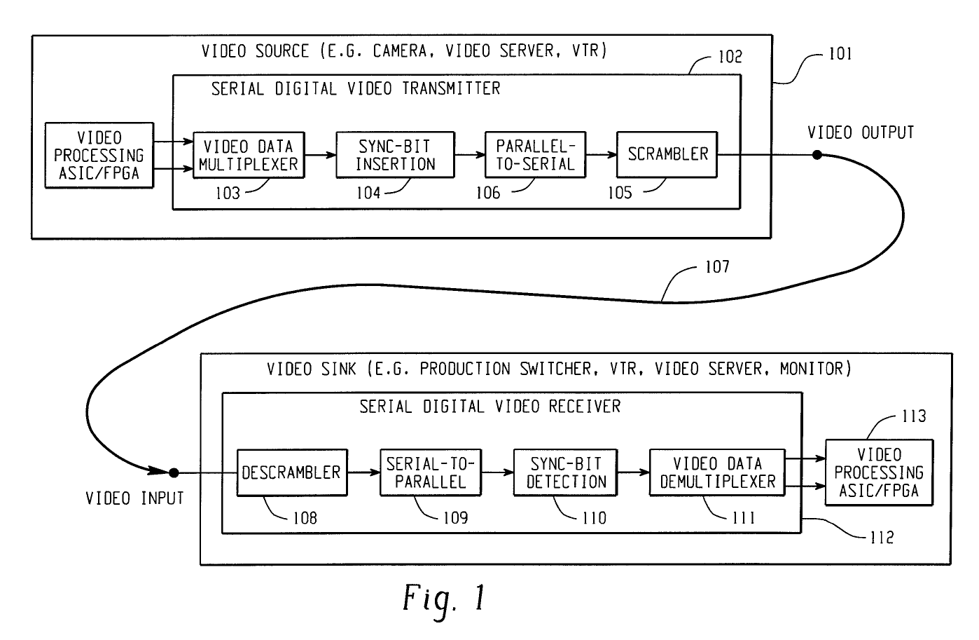

FIG. 1 is an example of a system in which the systems and methods described herein may be used. A video transmission system 101 is configured for inserting a sync-bit into a data stream. The system includes a serial digital video transmitter 102 that is configured to generate a serialized data stream. In one embodiment, the serial digital video transmitter could be contained on an ASIC, DSP, or other digital logic device known by those skilled in the art. The serial digital video transmitter 102 includes a video data multiplexer 103 that sends a multiplexed data stream to the sync-bit insertion module 104. The sync-bit insertion module 104 modifies the two least significant bits of data words in the preamble of the data stream in order to reduce the number of consecutive ones or zeros in the data stream, as is described in more detail below. The parallel data stream, following the sync-bit insertion module 104, is sent to the parallel to serial converter 105. The scrambler 106 applies a scrambling polynomial to the serialized data stream. The scrambled serialized data stream is transmitted via a video connection 107, including, but not limited to an electrical or optical video cable and a wireless connection, to a serial digital video receiver 112. A descrambling polynomial is applied to the scrambled serialized data stream in the descrambler 108 before transmission to the serial to parallel converter 109. The serialized data stream is sent to the serial to parallel converter 109 and then to the sync-bit detection 110, that is configured to detect the sync-bits inserted into the serialized data stream by the sync-bit insertion 104. The data stream is then transmitted to the video data demultiplexer 111. The individual data streams are now able to be processed by the video processing ASIC/FPGA 113.

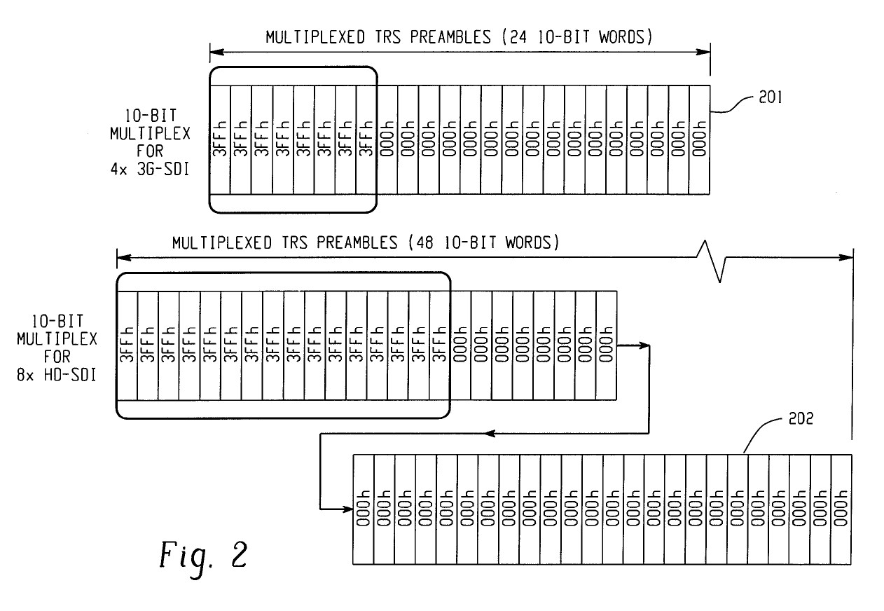

Referring now to FIG. 2, when the data streams are multiplexed, prior to serialization, the result is a parallel video data stream 201. Before being multiplexed, the TRS preambles 201 and 202 for each of the parallel video signals consist of two 10-bit words of all ones (3FFh) and four 10-bit words of all zeros (000h). Thus, for four multiplexed 2.97 Gb/s (3G-SDI) streams, the multiplexed TRS preambles 201 are 24 words long (8×3FFh and 16×000h). For eight multiplexed 1.485 Gb/s (HD-SDI) streams, the multiplexed TRS preambles 202 are 48 words long (16×3FFh and 32×000h).

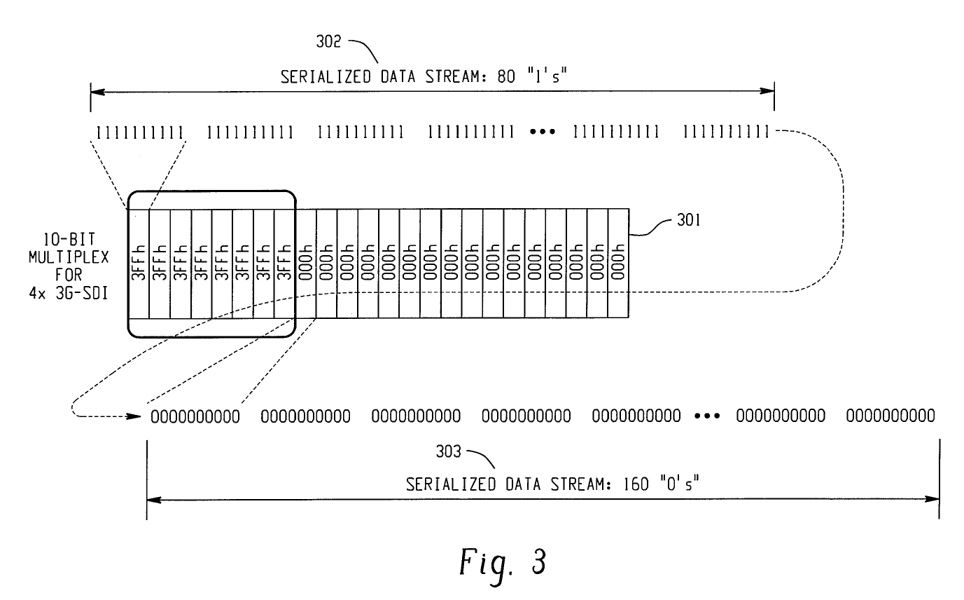

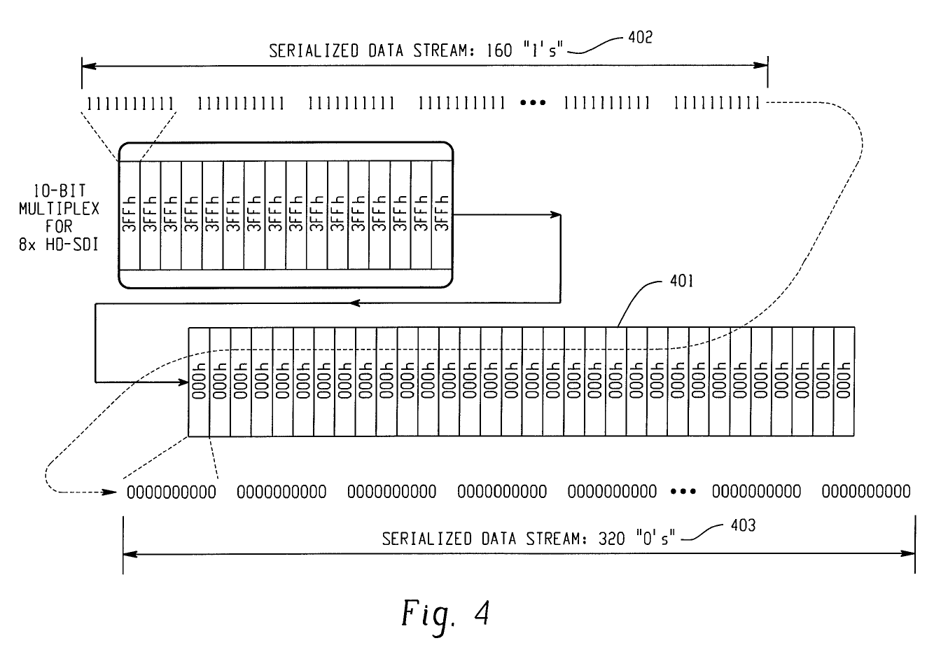

When the data streams shown in FIG. 2 are serialized, long runs of ones and zeros are fed into the scrambler. In FIGS. 3 and 4, the preambles of the parallel data streams 301 and 401 are serialized, resulting in serial data streams 302-303 and 402-403. The 3FFh words of the parallel data streams 301 and 401 are represented in serialized form by consecutive ones 302 and 402, and followed by the serialized 000h code words of the parallel data stream, which are represented by consecutive zeros 403 and 303. In FIG. 3, the four multiplexed 2.97 Gb/s (3G-SDI) serialized data stream 302-303 contains 80 consecutive ones 302 followed by 160 consecutive zeros 303. In FIG. 4, the eight multiplexed 1.485 Gb/s (HD-SDI) serialized data stream 402-403 contains 160 consecutive ones 402 followed by 320 consecutive zeros 403.

When the serial data streams 302-303 and 402-403 are scrambled using the polynomials in Equations 1 and 2, set forth below, it is possible that a run of 179 zeros or ones are produced from the serialized data stream 302-303 in FIG. 3, and a run of 339 zeros or ones are produced from the serialized data stream 402-403 in FIG. 4. These long runs of zeros and ones, although infrequent, will cause unwanted DC offsets on the serialized links.

NRZ generator polynomial: G1(X)=X̂9+X̂4+1 Eqn. 1

NRZI generator polynomial: G2(X)=X+1 Eqn. 2

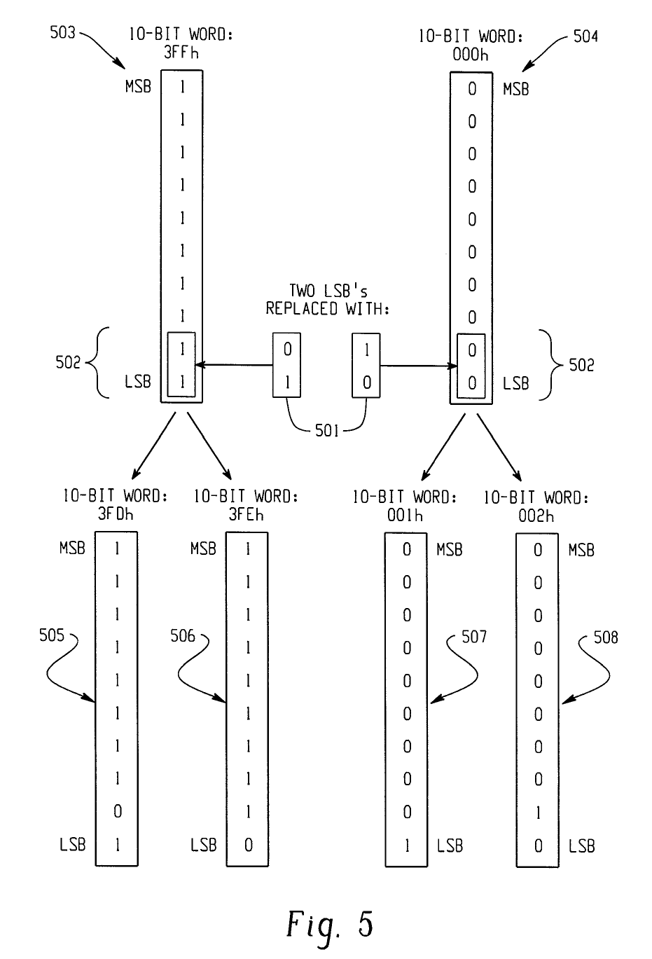

Referring now to FIG. 5, the proposed serial digital video transmitter prevents long runs of ones and zeros by inserting a “sync-bit” 501 into the two LSB's 502 of the parallel data stream 503 and 504, prior to the scrambler 106. Code words 503 and 504 represent one single code word from the parallel data stream 201 and 202. Code word 503 represents a 3FFh TRS code word and code word 504 represents a 000h TRS code word. The two LSB's 502 of code words 503 and 504 are modified from 11b or 00b to 01b or 10b, the “sync-bit” symbols 501. This results in two possible values each for the 3FFh and 000h words of the TRS preambles 201. The two possible values for the original 3FFh TRS code words are 3FDh 505 and 3FEh 506. The two possible values for the original 000h TRS code words are then 001h 507 and 002h 508. Since 3FFh and 000h can also occur in the ancillary data flag (ADF) preamble, in the combination of 000h/3FFh/3FFh, these data words will also be subjected to sync-bit insertion module 104.

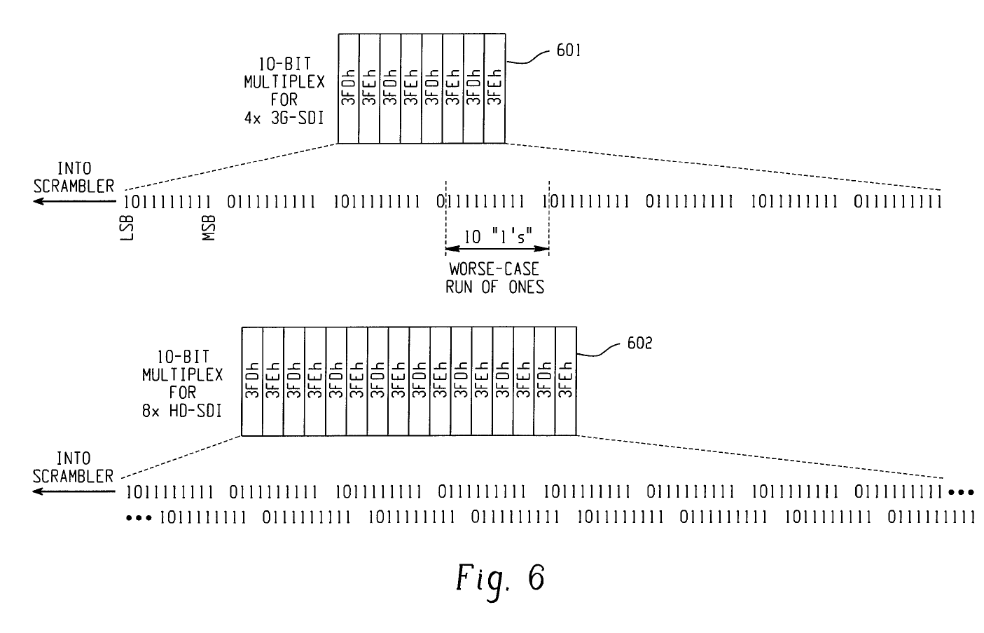

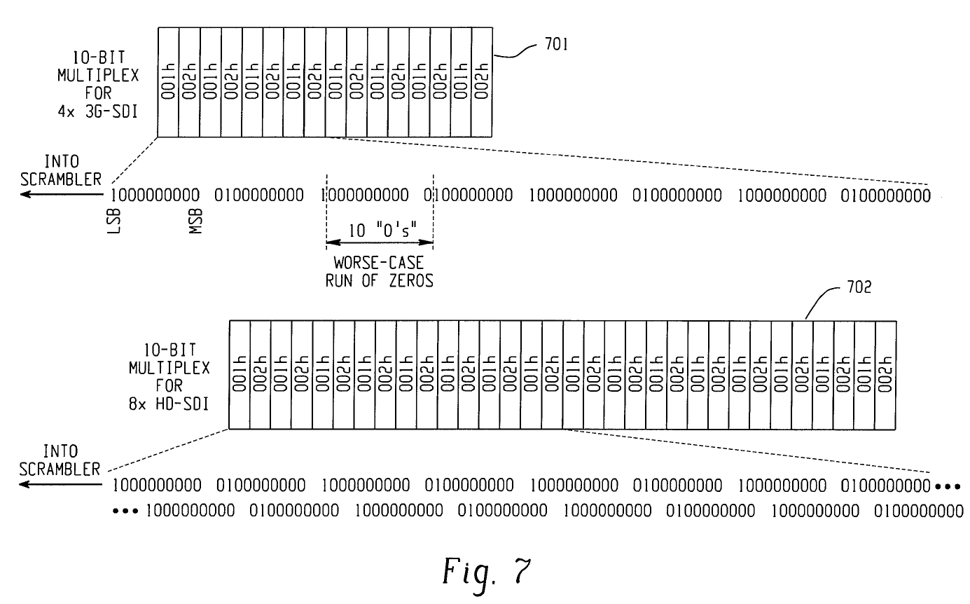

As shown in FIGS. 6 and 7, the parallel data stream 601, 602, 701, and 702 is modified such that sync-bit values are inserted alternatively, in the order of 01h followed by 10h for each data word. Once the sync-bit insertion and parallel to serial conversion has taken place, the serialized data stream feeding the scrambler, LSB first, will only contain a maximum run of 10 ones or zeros during the TRS preamble 201 and 202 (or ADF preamble). After scrambling, the maximum run of ones or zeros possible will be 29.

Sync-bit insertion is only applied to the 3FFh and 000h data words, which uniquely occur in the TRS and ADF preambles. The modified preamble values, 3FDh, 3FEh, 001h and 002h, are still illegal video code words, therefore, they cannot appear within the active video data stream. These data values are still unique enough such that data stream synchronization using the TRS is possible. Alternatively, TRS and ADF detect blocks need only look at the upper 8 bits of the 10-bit data words, which remain unchanged, in order to synchronize to the data streams.

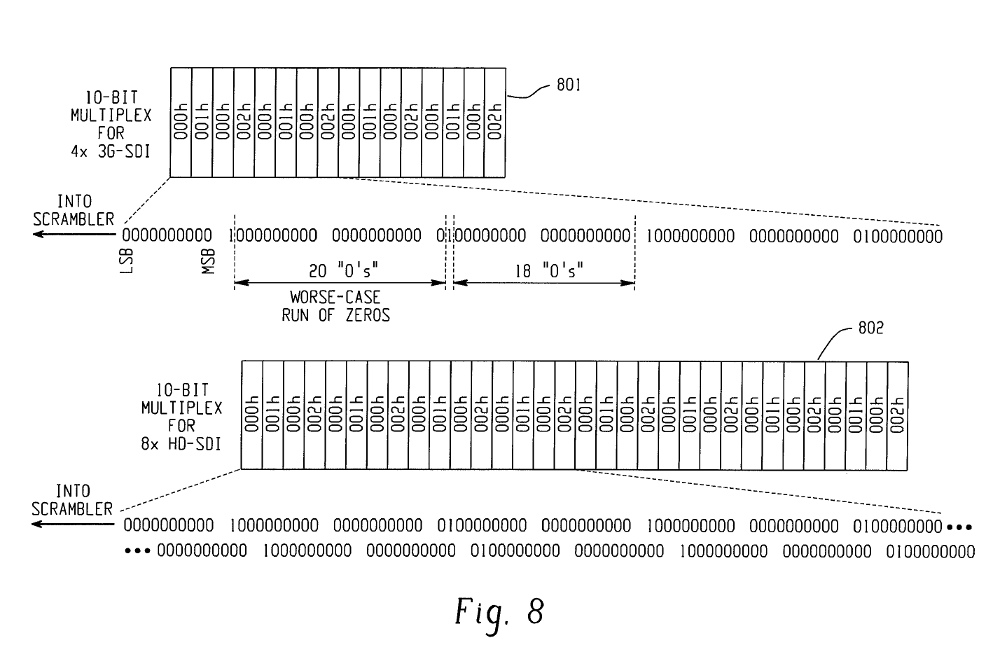

If longer runs of ones and zeros can be tolerated by the data transmission system, then the sync-bit insertion may be performed less periodically. The predetermined numbers of consecutive ones and zeros that are produced following sync-bit insertion is determined by the frequency of sync-bit insertion of the code words. For example, every other input data word in the data stream 801 and 802 is modified, as shown in FIG. 8. This results in a worse-case run of 20 zeros into the scrambler. After scrambling, the maximum run of ones or zeros possible will be 39.

This written description uses examples to disclose the invention, including the best mode, and also to enable a person skilled in the art to make and use the invention. The patentable scope of the invention may include other examples that occur to those skilled in the art.

It is claimed:

1. A video transmission system comprising:
a serial digital video transmitter configured to receive a parallel video stream, the parallel video stream including a preamble made up of parallel code words,
the serial digital video transmitter being further configured to modify the two least significant bits of a plurality of the parallel code words that make up the preamble of the parallel video stream,
the serial digital video transmitter being further configured to serialize the parallel video stream to generate a serial video signal that includes a serialized preamble,
wherein the modification of the two least significant bits of a plurality of the parallel code words prevents the serialized preamble from including more than a predetermined number of consecutive ones or zeros.

2. The video transmission system of claim 1, wherein the two least significant bits are modified in alternating values for each data word.

3. The video transmission system of claim 1, wherein modifying each of two least significant bits of a plurality of ten-bit data words in the preamble of the data stream is performed on every input data word.

4. The video transmission system of claim 1, wherein the high-definition serialized data stream is an ultra-high definition serialized data stream.

5. The video transmission system of claim 1, wherein the predetermined number of ones or zeros is determined by the number of parallel code words modified.

6. The video transmission system of claim 1, further comprising a connection between the serial digital video transmitter and a serial digital video receiver configured to transmit the serialized data stream.

7. The video transmission system of claim 1, further comprising a serial digital receiver configured to receive the scrambled high-definition serialized data stream.

8. The serial digital receiver of claim 7, configured to apply a descrambling polynomial to the scrambled high-definition serialized data stream to generate a descrambled serialized data stream, and to send the descrambled data stream to a detector configured to recognize the ten-bit data words containing the replaced values

9. The serial digital receiver of claim 8, wherein prior to detection of the first and second ten-bit data words containing the replaced values, the descrambled serialized data stream is converted to a parallel data stream.

10. A method of reducing long runs of static data in serial digital interfaces comprising:
receiving a data stream including a plurality of ten-bit data words in a high-definition video signal;
modifying each of two least significant bits of a plurality of ten-bit data words in the preamble of the data stream to reduce the number of consecutive ones or zeros in the data stream; and
after modifying the two least significant bits, applying a scrambling polynomial to the data stream to generate a scrambled high-definition serialized data stream.

11. The method of claim 10, wherein the two least significant bits are modified in alternating values for each data word.

12. The method of claim 10, wherein replacing each of two least significant bits of a plurality of ten-bit data words in the preamble of the data stream is performed on every input data word.

13. The method of claim 10, wherein the predetermined number of ones or zeros is determined by the number of parallel code words modified.

14. The method of claim 10, wherein the high-definition serialized data stream is an ultra-high definition serialized data stream.

15. The method of claim 10, wherein the scrambled high-definition serialized data stream is transmitted to a serial digital receiver.

16. The method of claim 15, wherein a descrambling polynomial is applied to the scrambled high-definition serialized data stream.

17. The method of claim 16, wherein the descrambled data stream enters a detector to recognize the first and second ten-bit data words containing the modified code words.

18. The method of claim 17, wherein prior to detection of the first and second ten-bit data words containing the modified code words, the descrambled serialized data stream is converted to a parallel data stream.

19. A serial digital video transmitter comprising:
a sync-bit insertion module, configured to receive a data stream including a plurality of ten-bit data words in a high-definition video signal;
the sync-bit insertion module being further configured to modify each of two least significant bits of a plurality of ten-bit data words in the preamble of the data stream to reduce the number of consecutive ones or zeros in the data stream; and
a scrambler configured to apply a scrambling polynomial to the data stream to generate a scrambled high-definition serialized data stream

20. The serial digital video transmitter of claim, 19 further comprising a multiplexer.

21. The serial digital video transmitter of claim 19, further comprising a parallel to serial converter, configured to convert a parallel data stream into a serialized data stream.

22. The serial digital video transmitter of claim 19, wherein the predetermined number of ones or zeros is determined by the number of parallel code words modified.

23. The serial digital video transmitter of claim 19, wherein the two least significant bits are modified in alternating values for each data word.

24. The serial digital video transmitter of claim 19, wherein modifying each of two least significant bits of a plurality of ten-bit data words in the preamble of the data stream is performed on every input data word.

25. The serial digital video transmitter of claim 19, wherein the high-definition serialized data stream is an ultra-high definition serialized data stream.
